(19) United States
(12) Patent Application Publication
(10) Pub. No.: US 2006/0130878 A1
(43) Pub. Date: Jun. 22, 2006

(54) Dish washer and control method thereof

(75) Inventors: Tae Hee Lee, Bucheon-si (KR); Sang Heon Yoon, Gwangmyeong-si (KR); Byung Keol Choi, Incheon-si (KR); Yang Hoon Chung, Incheon-si (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/297,377

(22) Filed: Dec. 9, 2005

(30) Foreign Application Priority Data
Dec. 10, 2004 (KR) P2004-104107
Apr. 4, 2005 (KR) P2005-28211

(51) Int. Cl. B08B 7/04; B08B 3/00; B08B 3/04

(52) U.S. Cl. 134/18; 134/56 D; 134/58 D; 134/104.4; 134/104.2; 134/10

(57) ABSTRACT

A dish washer includes a sump communicated with a tub to accommodate water, a water supply pump for pumping the water in the sump, a filtering device for receiving a part of the water pumped through an auxiliary passageway to filter the pumped water and to supply the filtered water to the sump again, and a bypass for bypassing the water to be supplied to the filtering device to the tub or the sump when the filtering device is blocked by sewage. The bypass includes a first sensor detecting water passing therethrough and the filtering device being blocked and transmitting the detected result to a controller, and a second sensor detecting and informing the water pollution level to the controller when the filtering device is blocked. A controlling method thereof determines an algorithm of a cycle for washing or rinsing dishes using information acquired from the first and the second sensors.

This application claims the benefit of Korean Patent Application Nos. P2004-104107, filed on Dec. 10, 2004 and P2005-28211, filed on Apr. 4, 2005, which is hereby incorporated by reference as if fully set forth herein.

### BACKGROUND OF THE INVENTION

1. Field of the Invention

The present invention relates to a dish washer, and more particularly, to a washing water supply for filtering and supplying washing water to a water jetting arm.

2. Discussion of the Related Art

A dish washer is an apparatus for jetting detergent and washing water to dishes to automatically wash the dishes. Generally, the dish washer includes a tub, a rack installed in the tub to place the dishes thereon, a sump provided below the tub to accommodate the washing water, a pump for pumping the washing water in the sump, at least one water jetting arm for jetting the washing water pumped from the pump toward the dishes placed on the rack, and an exhaust pump connected into the sump to exhaust the washing water in the sump. In operation mode, when the pump is driven, the water jetting arm jets the washing water in the sump toward the dishes, thereby washing the dishes. Moreover, the washing water jetted to the dishes is recovered to the sump, and is supplied to the water jetting arm by the pump again.

As described above, the washing water used to wash the dishes is recovered to the sump to be used in washing the dishes again. Thus, as washing time passes, the washing water in the sump is gradually contaminated. However, when critically contaminated washing water is continued to be used, the effectiveness of the washing is lowered as well as there is risk of blocking a passageway through which the washing water flows between the water jetting arm and the pump and/or a nozzle through the washing water is jetted. Thus, in order to prevent the water jetting arm and the nozzle from blocking, the contaminated washing water should periodically be exchanged with fresh water, if the washing water is frequently exchanged, too much washing water is consumed, and additional electric power is needed to heat the fresh washing water.

To prevent the above problem, a filtering device for filtering the washing water in the sump may be used. The filtering device can prevent the nozzle of the water jetting arm and/or the passageway from being blocked. However, when the filtering device is blocked due to garbage, since the washing water pumped from the pump cannot pass through the filtering device, the filtering device may be damaged or break down. To prevent this phenomenon, the washing water should be exchanged into fresh washing water periodically, so that a great deal of washing water is consumed and a lot of electric power is consumed to heat the fresh washing water.

Meanwhile, generally a dish washer performs the washing cycle and/or the rinsing cycle for as may times as it is predetermined number of times when washing and/or rinsing the dishes. For example, when a user inputs contamination degree and the amount of the dishes to be washed through a control panel, a controller, based on the input information, determines the number of times of the washing cycle and the rinsing cycle are to be performed and performs the determined cycles as many times as are determined. In this case, the washing cycle and the rinsing cycle are performed more times than is necessary so that the washing water and electric power may be wasted. On the contrary, the washing cycle and the rinsing cycle are performed less times than are necessary so that the dishes may be not washed effectively.

### SUMMARY OF THE INVENTION

Accordingly, the present invention is directed to a dish washer that substantially obviates one or more problems due to limitations and disadvantages of the related art.

An object of the present invention is to provide a dish washer capable of preventing washing water from being wasted during operation of the dish washer.

Another object of the present invention is to provide a dish washer for preventing components of the dish washer from being out of order when a filtering device is blocked during the operation of the dish washer.

Another object of the present invention is to provide a dish washer for accurately determining a pollution level of washing water during the washing cycle of the dish washer to reduce washing time, the amount of the washing water, and electric power consumption and to prevent poor washing of dishes.

To achieve these objects and other advantages and in accordance with the purpose of the invention, as embodied and broadly described herein, a dish washer including a sump communicated with a tub to accommodate water, a water supply pump for pumping the water in the sump, a filtering device for receiving a part of the water pumped through an auxiliary passageway to filter the pumped water and to supply the filtered water to the sump again, and a bypass for bypassing the water to be supplied to the filtering device to the tub or the sump when the filtering device is blocked by sewage.

The filtering device includes a sewage chamber for accommodating the water and the sewage entering through the auxiliary passageway, and a filter provided above the sewage chamber to filter the water overflowing from the sewage chamber.

The bypass is configured to connect the filtering device to the tub or the sump, or the auxiliary passageway to the tub or the sump. The bypass includes a part positioned higher than the filtering device such that the water entering the filtering device is prevented from flowing toward the tub or the sump when the filtering device is not blocked.

The dish washer further includes a sensor for detecting whether the filtering device is blocked or not by detecting the water flowing toward the tub or the sump through the bypass.

The dish washer further includes a tank provided in the intermediate region of the bypass to deposit sewage contained in the water flowing toward the filtering device.

The dish washer further includes an exhaust pump communicated with the sump such that the water in the sump is exhausted through an exhaust hose and sewage contained in the water flowing toward the filtering device is deposited in the exhaust pump. The exhaust hose includes a part disposed higher than the bypass to prevent the water entering the exhaust pump through the auxiliary passageway from exhausting when the water passes through the bypass.

The dish washer further includes a sensor provided in the bypass to measure the pollution level of the water when the water passes through the bypass. The sensor is disposed higher than the filtering device such that the sensor is prevented from being activated by the water when the filtering device is not blocked.

In another aspect of the present invention, a controlling method of a dish washer includes the steps of 1) performing a washing cycle or a rinsing cycle, 2) monitoring whether a filtering device, through which water passes, is blocked due to sewage or not, 3) repeating the washing cycle or the rinsing cycle until the filtering device is not blocked, and 4) further performing the washing cycle or the rinsing cycle once again when the filtering device is not blocked until one of the washing cycle or the rinsing cycle is completed and finishing the repetition of the washing cycle or the rinsing cycle.

The step of monitoring whether the filtering device is blocked or not is performed by detecting whether the water to be supplied to the filtering device flows through a bypass for communicating a tub for accommodating dishes or a sump for accommodating the water to the filtering device.

The controlling method of a dish washer further includes the step of outputting an error message when the rinsing cycle or the washing cycle is performed as many times as a predetermined threshold number of performance times.

The controlling method of a dish washer further includes the step of heating the water and performing an additional rinsing cycle with the heated water after a final rinsing cycle.

In another aspect of the present invention, a controlling method of a dish washer includes the steps of 1) pumping and jetting water toward dishes accommodated in a tub, 2) filtering the water with a filtering device, and 3) bypassing the water to be supplied to the filtering device through a bypass to the tub or a sump for accommodating the water when the filtering device is blocked.

The controlling method of a dish washer further includes the steps of detecting whether the water flows toward the tub or the sump through the bypass or not, and exhausting and re-supplying the water when the water flows toward the tub or the sump through the bypass.

Alternatively, the controlling method of a dish washer further includes the steps of detecting whether the water flows toward the tub or the sump through the bypass or not, and repeating a corresponding cycle once again after the corresponding cycle is finished when the water flows toward the tub or the sump through the bypass.

Alternatively, the controlling method of a dish washer further includes the steps of measuring the pollution level of the water flowing toward the tub or the sump through the bypass, and exhausting the water when the measured pollution level exceeds a predetermined pollution level and re-supplying the water.

Alternatively, the controlling method of a dish washer further includes the steps of measuring the pollution level of the water again when the filtering device is blocked again after the re-supply of the water, and comparing a combination of a pattern of the pollution level measured prior to the re-supply of the water and a pattern of the pollution level measured after the re-supply of the water with a predetermined pattern to determine the pollution level of the water.

The controlling method of a dish washer further includes the step of compensating the number of washing times or the number of rinsing times after the re-supply of the water.

In the controlling method of a dish washer, the pollution level of the water is measured based on the intensity of output voltage generated from a sensor according to the amount of light passing through the water passing through the bypass.

The controlling method of a dish washer further includes the step of adjusting reference values for determining the pollution level of the water after the re-supply of the water by increasing the reference values.

Meanwhile, in another aspect of the present invention, a controlling method of a dish washer includes the steps of 1) performing a washing cycle or a rinsing cycle at least twice, 2) detecting water when a filtering device is blocked during respective cycles and outputting signals according to the pollution levels of the water, and 3) comparing a combination of patterns of the signals outputted during the cycles performed twice with a predetermined pattern to determine the pollution level of the water.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating a dish washer according to a first preferred embodiment of the present invention;

FIG. 2 is a diagram illustrating flow of washing water when a filtering device of the dish washer of FIG. 1 is blocked;

FIG. 3 is a diagram illustrating flow of washing water in the exhausting cycle of the dish washer of FIG. 1;

FIG. 4 is a flowchart illustrating a control method of the dish washer of FIG. 1;

FIG. 5 is a diagram illustrating a dish washer according to a second preferred embodiment of the present invention;

FIG. 6 is a diagram illustrating a modification of the dish washer of FIG. 6;

FIG. 7 is a diagram illustrating flow of washing water when a filtering device of the dish washer of FIG. 5 is blocked;

FIG. 8 is a graph illustrating voltages outputted by sensors of the dish washers in FIGS. 5 and 6, which are provided between a water supply pump and a filtering device to measure pollution level of washing water, according to pollution level;

FIG. 9 is a graph illustrating voltages outputted from sensors of the dish washers in FIGS. 5 and 6, which are provided in a bypass for communicating a filtering device with a tub, according to pollution level; and

FIG. 10 is a flowchart illustrating a control method of the dish washers in FIGS. 5 and 6.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

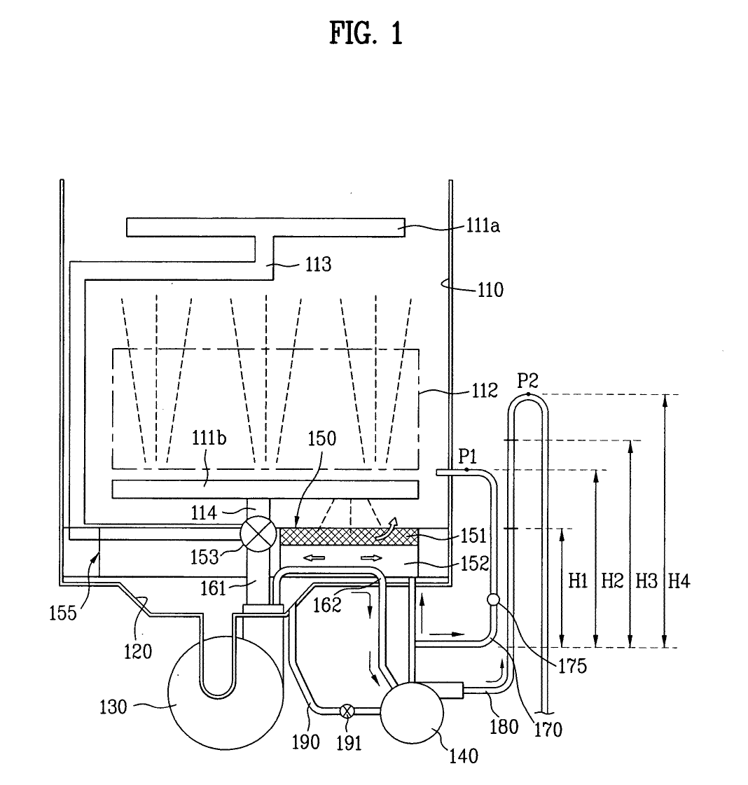

FIG. 1 schematically illustrates a dish washer according to a preferred embodiment of the present invention. A tub 110 of the dish washer include at least one rack on which dishes are placed, and at least one water jetting arm installed in the vicinity of the rack to jet washing water to the dishes. For reference, as shown in FIG. 1, two racks, that is, an upper rack (not shown) and a lower rack 112, are provided in the tub 110, and two water jetting arms, that is, an upper water jetting arm 11a and a lower water jetting arm 111b are provided in the lower sides of the upper rack and the lower rack 112.

A washing water supply is provided in the lower side of the tub 110. The washing water supply supplies washing water to the upper water jetting arm 111a and the lower water jetting arm 111b and filters washing water used to wash the dishes. Hereinafter a structure of the washing water supply is described in detail.

The washing water supply is provided with a sump 120. The sump 120 accommodates washing water, as shown in FIG. 1, and is installed in the lower side of the tub 110 to communicate with the tub 110. The sump 120 accommodates clean washing water supplied from exterior in the water supplying cycle as well as dirty washing water dropped down after washing the dishes in the tub 110 in the washing cycle. The sump 120 may be provided with a heater (not shown) for heating washing water therein. If the heater is provided, since the dishes can be washed with hot washing water, the washing effectiveness of the dish washer can be enhanced.

A water supply pump 130 is connected to the sump 120, pumps to supply washing water accommodated in the sump 120 to the water jetting arms, that is, the upper water jetting arm 111a and the lower water jetting arm 111b. a part of the washing water pumped from the sump 120 by the water supply pump 130 is supplied to the water jetting arms, that is, the upper water jetting arm 111a and the lower water jetting arm 111b. In order to guide the pumped washing water to respective water jetting arms, the washing water supply, as shown in FIG. 1, is provided with a main passageway 161. The main passageway 161 is connected to an upper connection pipe 113 connected to the upper water jetting arm 111a and a lower connection pipe 114 connected to the lower water jetting arm 111b, respectively.

At the point where the main passageway 161, the upper connection pipe 113, and the lower connection pipe 114 are connected to each other, a diverting valve 153 is installed to divert passageways so as to selectively or simultaneously supply the washing water pumped from the water supply pump 130 to the upper water jetting arm 111a and the lower water jetting arm 111b.

As described above, a part of the washing water pumped from the water supply pump 130 is supplied to the respective water jetting arms by the main passageway 161 and the respective connection pipes. Further, the remainder of the washing water pumped from the sump 120 by the water supply pump 130 is filtered and is supplied to the sump 120 again. To this end, the dish washer according to this preferred embodiment of the present invention is provided with an auxiliary passageway 162 and a filtering device 150.

The auxiliary passageway 162 connects the water supply pump 130 to the filtering device 150 to guide the remainder of the pumped washing water to the filtering device 150, the filtering device 150 removes sewage contained in the washing water supplied through the auxiliary passageway 162 and supplies the filtered clean washing water to the sump 120 again.

The filtering device 150, for example as shown in FIG. 1, includes a sewage chamber 152 and a filter 151. The sewage chamber 152 has sufficient space to accommodate the washing water and sewage introduced thereinto through the auxiliary passageway 162 and an opened upper side. Since the water supply pump 130 pumps the washing water in the sump 120 at a high pressure, the pumped washing water reaches the sewage chamber 152. When the washing water is further supplied into the sewage chamber 152, the level of the sewage chamber 152 is increased, and then the washing water eventually overflows through the upper side thereof.

The filter 151 is provided at the opened upper side of the sewage chamber 152. Thus, the washing water overflowed from the sewage chamber 152 passes through the filter 151 and is filtered. Here, the filter 151 preferably has a mesh of a size capable of filtering relatively fine sewage. The sewage filtered by the filter 151 remains in the sewage chamber 152. On the other hand, the washing water overflowed from the sewage chamber 152 is filtered by the filter 151 and drops down. Meanwhile, since the sewage chamber 152 is disposed above the sump 120, the clean washing water filtered by the filter 151 is finally recovered into the sump 120.

As described above, the filtering device 150 filters relatively fine sewage using the filter 151. However, the filter 151 may be easily blocked by large and coarse sewage. Thus, in the dish washer according to this preferred embodiment of the present invention, a device capable of filtering coarse sewage contained in the washing water to be supplied to the filtering device 150 through the auxiliary passageway 162 is further provided, and will be described in detail as follows.

In order to deposit coarse sewage before the washing water flowing through the auxiliary passageway 162 reaches the filtering device 150, a tank having a large space is disposed in the intermediate of the auxiliary passageway 162. The tank may be installed in the washing water supply as a separate component. However, in order to reduce the number of components and manufacturing costs, in the dish washer according to this preferred embodiment of the present invention, preferably, an exhaust pump 140, as shown in FIG. 1, is used as the tank. The reason is described as follows.

The exhaust pump 140 is used to exhaust the contaminated washing water out when the washing water in the sump 120 is heavily contaminated. To this end, the sump 120 and the exhaust pump 140 are connected to each other by an exhaust passageway 190 having an exhaust valve 191 for opening and closing the exhaust passageway 190. The exhaust valve 191 is closed to prevent the washing water from flowing toward the exhaust pump 140 in the sump 120 during the washing cycle, and is opened to make the washing water in the sump 120 flow toward the exhaust pump 140 during the exhausting cycle.

The exhaust pump 140, generally, includes a generally motor (not shown), an impeller (not shown), and an impeller housing (not shown) for surrounding the impeller. Here, the impeller housing is provided with a space sufficient to accommodate the washing water such that the washing water accommodated in the impeller housing is exhausted out when the rotation of the impeller. Thus, the impeller housing of the exhaust pump 140 having a wide space for accommodating the washing water is properly used as a tank for depositing and filtering sewage in the washing water.

The tank, that is, the exhaust pump 140 is disposed below the filtering device 150. This reason why is heavy sewage is easily deposited in the exhaust pump 140 due to its own weight when the washing water passes through the exhaust pump 140 and flows to the filtering device 150. Meanwhile, in order to improve the filtering performance of the exhaust pump 140, although not shown, an auxiliary filter (not shown) is further provided in the impeller housing of the exhaust pump 140.

When the auxiliary filter is provided, light sewage, which is not deposited due to pumping pressure, of sewage contained in the washing water flowing toward the filtering device 150 can be filtered. However, if the auxiliary filter filters very fine sewage, the passageway through which the washing water passes is easily blocked and the exhaust pump 140 may stop working. Thus, preferably, the auxiliary filter 151* has a mesh of a size capable of filtering nearly coarse sewage.

In order to make the washing water supply according to the present invention into a competitive product, the washing water supply is preferably compact. To this end, components such as main passageway 161, the diverting valve 153, the auxiliary valve 162, and the filtering device 150, as shown in FIG. 1, may be constructed into a single assembly 155. The upper connection pipe 113, the lower connection pipe 114, the water supply pump 130, and the exhaust pump 140 are organically connected to the assembly 155. However, the connection is not limited to this. For example, the auxiliary passageway 162 may be formed in the assembly 155 in the form of channel or a separate pipe. As another example, a part of the auxiliary passageway 162 is formed in the assembly 155 in the form of a channel, and the remainder may be formed in the form of a pipe.

Meanwhile, since the filtering device 150 filters fine sewage, the filter 151 may possibly become blocked when the amount of sewage is large. Thus, to prevent this phenomenon, the lower water jetting arm 111b, as shown in FIG. 1, jets some washing water toward the filter 151. Then, sewage attached to the filter 151 is detached from the filter 151 and accommodated in the sewage chamber 152 so that the filter 151 can be prevented from blocking.

However, when the washing time is long and the amount of sewage is large, the filter 151 while inevitably become blocked. In this case, since the washing water entering the sewage chamber 152 cannot easily pass through the filter 151, the pressure in the sewage chamber 152 is increased.

As the pressure in the sewage chamber 152 is increased, the filter 151 has a large force applied. In this case, the filter 151 may be deformed. Thus, to prevent the deformation of the filter 151, the exhaust pump 140 may exhaust the washing water out, but this may result in wasted washing water.

To prevent the above-described problem, the washing water supply of the present invention is provided with a bypass 170. The bypass 170 has an inlet communicated with, for example, the auxiliary passageway 162, in more detail, between the exhaust pump 140 and the filtering device 150, and an outlet communicated with, for example, the tub 110. The bypass 170 includes a part Pi disposed higher than the height H1 of the filtering device 150. The reason is to effectively prevent the washing water entering the filtering device 150 from directly flowing toward the tub 110 through the bypass 170 after pumping when the filtering device 150 is not blocked.

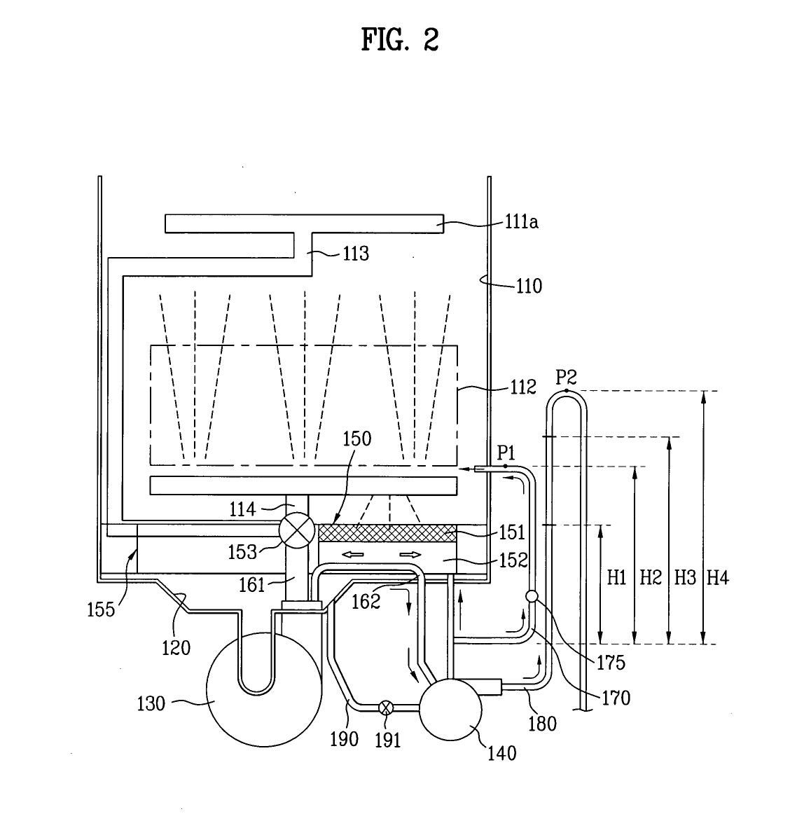

For example, when the outlet of the bypass 170, as shown in FIG. 1, is positioned at the position H2 higher than the height H1 of the filtering device 150, due to the difference H2−H1 between the heights of the outlet of the bypass 170 and the filtering device 150, the pumped washing water is not exhausted through the outlet of the bypass 170 but overflows through the filtering device 150 when the filter 151 of the filtering device 150 is not blocked. Thus, when the filtering device 150 is not blocked, the washing water is prevented from flowing toward the tub 110 through the bypass 170. On the other hand, as shown in FIG. 2, when the filter 151 of the filtering device 150 is blocked, since the pumped washing water does not overflow through the filtering device 150, the washing water gradually ascends through the bypass 170 and finally is discharged into the tub 110 through the outlet of the bypass 170.

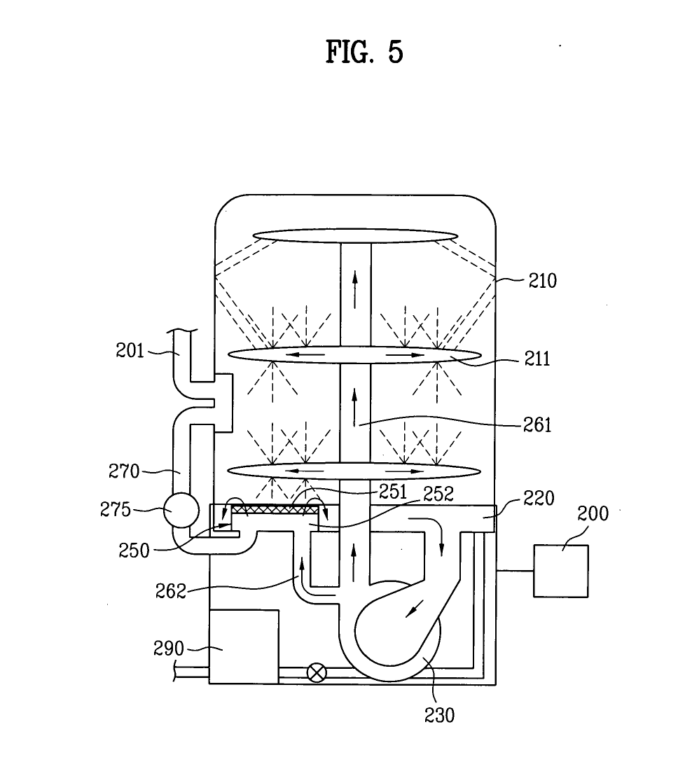

Alternatively, even not depicted in FIGS. 1 and 2, the outlet of the bypass 170 may be connected to the sump 120, not the tub 110. Even in this case, the bypass 170 has the part disposed higher than the filtering device 150. Alternatively, the inlet of the bypass 170 may be not connected to the auxiliary passageway 162, as shown in FIG. 5, but to the filtering device 150, in more detail, to the sewage chamber 152.

As described above, the bypass 170 is provided to bypass the washing water supplied to the filtering device 150 toward the tub 110 or the sump 120 when the filtering device 150 is blocked by sewage, so that the filter 151 can be effectively prevented from being deformed due to the high pressure and the water supply pump 130 is also effectively prevented from malfunctioning due to the back pressure. Additionally, the bypass 170 is provided so that some washing water is filtered by the filtering device 150 and can be further used to wash and/or rinse the dishes without directly exchanging with fresh washing water. Thus, the amount of the washing water and power consumption for heating new fresh washing water can both be reduced.

Meanwhile, the dish washer according to the preferred embodiment of the present invention may further include a sensor (hereinafter referred to as a first sensor) for detecting whether the filtering device 150 is blocked or not. The first sensor 175 is installed, for example, in the bypass 170, and detects whether the washing water flows toward the tub 110 or the sump 120 through the bypass 170.

As the first sensor 175, a pressure switch, a pressure sensor, an optical sensor, and a float switch may be used. The first sensor 175 is electrically connected to a controller (See FIG. 5) of the dish washer, and detects that the washing water passes through the bypass 170 to transmit a signal to the controller.

When the pressure switch and the pressure sensor are used as the first sensor 175, the first sensor 175 may be designed to transmit a signal to the controller only when more than a predetermined pressure is applied to the inside of the bypass 170. For example, the washing water does not flow through the bypass 170 or a small amount of the washing water flows through the bypass 170 when the filtering device 150 is not blocked, at this time, a static pressure is applied to the inside of the bypass 170. On the contrary, when the filtering device 150 is blocked, a great deal of the washing water flows toward the tub 110 or the sump 120, and at that time, the bypass 170 has a dynamic pressure applied.

Thus, the first sensor 175 is designed to transmit a signal to the controller only when a dynamic pressure is applied, and the controller can determine whether the filtering device 150 is blocked or not based on the signal from the first sensor 175. Meanwhile, when a pressure switch and a pressure sensor as the first sensor 175 are used, the first sensor 175 may be installed any position of the bypass 170.

On the contrary, the optical sensor and the float switch do not distinguish the static pressure from the dynamic pressure, but checks whether the washing water passed through the position where the first sensor 175 is installed, or not. Thus, when the optical sensor and the float switch are used as the first sensor 175, the first sensor 175 may be preferably installed in the outlet of the bypass 170, in the vicinity thereof, or in the highest position of the outlet of the bypass 170.

As such, when the first sensor 175 for detecting whether the filtering device 150 is blocked or not is provided, the controller can adjust the times and the duration of the washing cycle and the rinsing cycle. Thus, the present invention can provide suitable algorithms for the washing cycle and the rinsing cycle related to the pollution level of the dishes, and a detailed description will be followed.

Meanwhile, as shown in FIG. 1, the exhaust pump 140 is connected to an exhaust hose 180. The exhaust hose 180 may include a part P2 disposed higher than the highest part P1 of the bypass 170. For example, the intermediate portion of the exhaust hose 180 is bent in the form of a reversed U-shape, and the bent portion P2 is disposed higher than the highest part P1 of the bypass 170. Then, since there is a height difference H4−H2 between the part P2 of the exhaust hose 180 and the part P1 of the bypass 170, when the washing water flows toward the tub 110 through the bypass 170, the washing water entering the exhaust pump 140 through the auxiliary passageway 162 can be effectively prevented from being discharged out through the exhaust hose 180.

As described above, since the part P2 of the exhaust hose 180 effectively prevents the washing water from being exhausted when the exhaust pump 140 does not work, there is no need to install a separate check valve in the exhaust hose 180. However, alternatively, when the exhaust hose 180 is provided with a separate check valve, the exhaust hose 180 may have no the part disposed at a high position such as P2.

Meanwhile, the dish washer works during the washing cycle or the rinsing cycle for rinsing the dishes as follows. Firstly, when the water supply pump 130 is driven, some of the washing water accommodated in the sump 120 enters the main passageway and is guided to at least one of the upper water jetting arm 111a and the lower water jetting arm 111b by the diverting valve 153. The washing water supplied to the water jetting arm is jetted toward the dishes placed on the rack through the nozzle formed in the water jetting arm, and then the dishes are washed or rinsed. After washing or rinsing the dishes, the contaminant washing water drops down on the bottom of the tub 110 and is accommodated in the sump 120 again.

The remainder of the washing water pumped from the water supply pump 130 enters the exhaust pump 140 through the auxiliary passageway 162. At that time, when large sized garbage is deposited in the exhaust pump 140, not-deposited fine sewage and the washing water enter the sewage chamber 152 through the auxiliary passageway 162. The washing water and the sewage entering the sewage chamber 152 fill the sewage chamber 152 and overflow through the filter 151. At that time, the sewage remains in the sewage chamber 152 and only the filtered washing water overflows from the sewage chamber 152 and returns to the sump 120.

When the washing water overflows from the sewage chamber 152, since the outlet of the bypass 170, as shown in FIG. 1, is disposed higher than the sewage chamber 152, the washing water passing through the auxiliary passageway 162 does not flow into the tub 110 or the sump 120 through the bypass 170. Moreover, since the level in the exhaust hose 180 maintains the same level H1 as or a higher level than the level of the filtering device 150, the washing water is also not exhausted through the exhaust pose 180.

Meanwhile, in the early stage of the washing cycle, a great deal of sewage is contained in the washing water. Thus, a great deal of sewage enters the sewage chamber 152, and the filter 151 is blocked by the filtered sewage. As such, when the filter 151 is blocked, the water pressure of the water supply pump 130 is concentrated to the exhaust pump 140 and the auxiliary passageway 162.

At that time, the washing water of the auxiliary passageway 162, as shown in FIG. 2, is discharged into the tub 110 or the sump 120 through the bypass 170. This reason is why the water pressure concentrated to the auxiliary passageway 162 is sufficiently increased to exceed the potential energy difference between the outlet of the bypass 170 and the filtering device 150.

Moreover, no washing water is discharged out through the exhaust hose 180. This reason why is as the washing water is discharged into the tub 110 or the sump 120 through the bypass 170, the water pressure of the auxiliary passageway 162 is not increased sufficiently to exceed the highest position P2 of the exhaust hose 180. At that time, since the level of the washing water in the exhaust hose 180 does not reach the highest position, for example, the level is maintained near the level H3, but does not reach the highest height H4 of the exhaust hose 180, the washing water is not discharged out through the exhaust hose 180.

Meanwhile, in the exhausting cycle of the dish washer, when the exhaust pump 140 is driven, the washing water and the garbage in the sump 120 enter the exhaust pump 140 through the exhaust passageway 190. Following that, the washing water and the sewage, having entered the exhaust pump 140, are discharged out through the exhaust hose 180 by the pumping power of the exhaust pump 140. At that time, the washing water and the sewage overflow the highest position P2 of the exhaust hose 180 and are exhausted out, and all the washing water in the exhaust hose 180 is exhausted out due to a siphoning effect.

Meanwhile, the present invention further provides a method for effectively controlling the dishwasher according to the first preferred embodiment of the present invention operated as described above. The controlling method of the dish washer according to the preferred embodiment of the present invention monitors whether the filtering device 150 is blocked or not when the dish washer is operated, and reflects the monitored result to the number of times and duration of the washing cycle and the rinsing cycle. Thus, the controlling method of the dishwasher provides a suitable washing and rinsing algorithm for the pollution level of the dishes to be washed. The controlling method of the dishwasher according to the preferred embodiment of the present invention includes the following steps.

Firstly, the washing cycle for separating sewage attached to the dishes from the dishes with detergent or the rinsing cycle for rinsing the washed dishes with clean washing water is performed. During the washing cycle or the rinsing cycle, the controller keeps in monitoring whether the filtering device 150 for filtering the washing water is blocked by the sewage or not. Here, the method for monitoring whether the filtering device 150 is blocked or not has already been described above. In other words, whether the washing water to be supplied to the filtering device 150 after the washing water is pumped by the water supply pump 130 flows toward the tub 110 or the sump 120 through the bypass 170 or not is monitored with the first sensor 175 installed to the bypass 170.

As described above, when there is a large amount of sewage, the filtering device 150 is blocked during the washing cycle or the rinsing cycle. Then, the washing water to be supplied to the filtering device 150 flows to the tub 100 or the sump 120 through the bypass 170, and this information is transmitted to the controller through the first sensor 175. The controller, then, exhausts the washing water directly after receiving the information, after receiving the information and a predetermined time lapses, or after performing a corresponding cycle for a determined time regardless of the information.

After exhausting the washing water, the washing water is supplied to the sump 120 again, and the previous cycle is repeated. This repetition of same cycle is continued until the filtering device 150 is not stopped while any one cycle is performed. What the filtering device 150 being blocked during the washing cycle or the rinsing cycle means is that the dishes are still heavily contaminated. Thus, if the filtering device 150 is blocked during the performance of any one cycle, the controlling method according to the preferred embodiment of the present invention, exhausts the washing water and repeats the same cycle again in order to prevent the dish washing from finishing when the dishes are not completely washed.

When the filtering device 150 is not stopped until finishing any one of the washing cycle or the rinsing cycle, this means that the dishes are nearly washed or rinsed. Thus, the controller performs the washing cycle or the rinsing cycle once again, and finishes the repeating the same cycle.

When less sewage is contained in the washing water, for example, when less sewage is attached to the dishes or the number of the dishes is small, the repetition times of the rinsing cycle would be decreased. On the contrary, when much sewage is contained in the washing water, the repetition times of the rinsing cycle would be increased. Thus, according to the controlling method of the preferred embodiment of the present invention, the repetition times of the rinsing cycle can be properly adjusted according to the pollution level of the washing water.

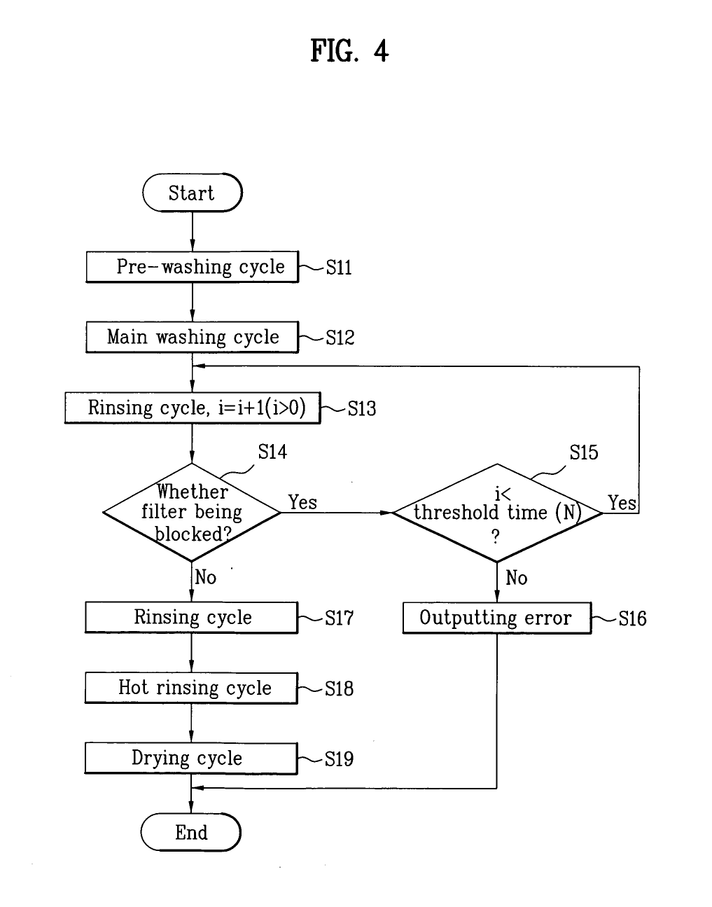

Hereinafter, how to actually apply the controlling method of the dish washer according to the preferred embodiment of the present invention when the performance of the dish washer will be described with reference to FIG. 4. FIG. 4 shows the washing cycle and the rinsing cycle respectively including several sub-cycles, and the controlling method for performing the rinsing cycle after a main washing cycle. However, by a user's choice, only any one cycle can be performed among the several sub-cycles as described above, and in this case, the controlling method according to the preferred embodiment of the present invention can be applied to the corresponding sub-cycle. The controlling method according to the preferred embodiment of the present invention can be applied to the respective sub-cycles as shown in FIG. 4, or two or more sub-cycles among the sub-cycles. Meanwhile, the exhausting cycle is performed every interval between the respective sub-cycles, but the exhausting cycle between the respective sub-cycles is not depicted for the purpose of a simple drawing.

Firstly, the washing water is jetted to the dishes to perform a pre-washing cycle (S11). During the pre-washing cycle, sewage attached to the dishes is separated and dry sewage attached to the dishes is soaked. After the pre-washing cycle, the exhausting cycle is performed.

Continuously, the main washing cycle is performed (S12). During the main washing cycle, the washing water containing detergent is jetted toward the dishes. At that time, the dishes are effectively washed due to friction between the dishes and the washing water as well as the emulsification of the detergent.

After the washing cycle, the exhausting cycle is performed, and the rinsing cycle is performed after the exhausting cycle (S13). During the rinsing cycle, the first sensor 175 and the controller monitor whether the filtering device 150 is blocked or not, and as a result of the monitoring, when it is determined that the filtering device 150 is blocked, the rinsing cycle is repeated (S14).

To say again, when the filtering device 150 is blocked by sewage, the rinsing cycle is repeated once again, and when that the filtering device 150 is blocked again in the middle of repeating the rinsing cycle, the rinsing cycle is repeated once again. As such, the rinsing cycle is repeated until the filtering device 150 is not blocked. Between every rinsing cycle, an exhausting cycle is performed.

Meanwhile, when it is determined that the times i of the rinsing cycle reaches a threshold time N predetermined in the controller, the dish washer is preferably stopped (S15). This reason why the rinsing cycle is prevented from continuously repeating when sewage is so tightly inserted into the filtering device 150 that the sewage is not separated from the filtering device 150 or dry sewage is attached to the filtering device 150.

In this case, preferably, an error message is outputted for a user to easily recognize this situation (S16). The error message is visually outputted on a display such as a liquid crystal display, a light emitting diode, and the like, and/or is outputted as a sound alarm, or another manner, so that the user can easily recognize the situation.

Meanwhile, when it is determined that the filtering device 150 is not blocked, a final rinsing cycle is repeated once again (S17). During the final rinsing cycle, it is not determined whether the filtering device 150 is stopped or not. Thus, the final rinsing cycle is performed only once.

After the final rinsing cycle, a hot rinsing cycle may be further performed (S18). At this time, the heater installed in the sump 120 is operated to heat the washing water up to a predetermined temperature. During the hot rinsing cycle, the dishes are heated and sterilized.

After the hot rinsing cycle, a drying cycle may be performed (S19). At that time, the washing water is not jetted, and a separate heater (not shown) installed in the tub 110 is operated. After finishing the drying cycle, all performances of the dish washer are finished.

According to the controlling method of a dish washer of the preferred embodiment of the present invention, the time of the washing cycle or the rinsing cycle is varied according to the amount of sewage. Thus, in a case of low a pollution level of the washing water, the numbers of times the washing cycle and the rinsing cycle are performed are reduced so that the amount of the washing water and the power consumption can be saved. Moreover, in a case of a high pollution level of the washing water, the number of times the rinsing cycle is performed is increased so that the dishes can be effectively washed.

The dish washer according to the first preferred embodiment of the present invention and its controlling method as described above indirectly determine the pollution level of the dishes by determining whether the filtering device is blocked or not, and apply the determined result to the washing and the rinsing algorithms. The present invention is not limited to this, and further provides a dish washer and a controlling method thereof according to a second preferred embodiment for directly measuring the pollution level of the washing water and applying the measuring result to the washing and the rinsing algorithms. Hereinafter, the dish washer according to the second preferred embodiment of the present invention and the controlling method thereof will be described.

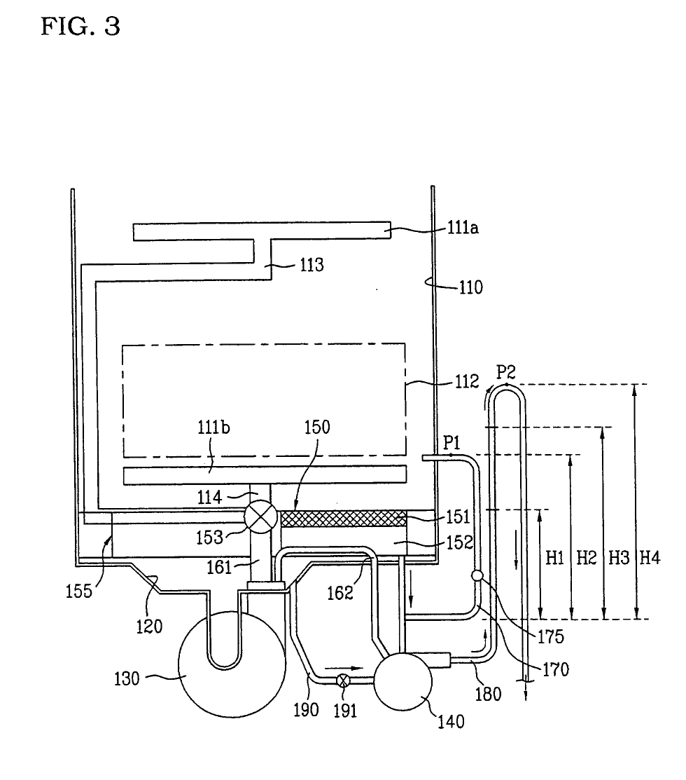

FIG. 5 shows the dish washer according to the second preferred embodiment of the present invention. As shown in the drawing, the structure of the dish washer according to the second preferred embodiment of the present invention is not very different from that of the dish washer according to the first preferred embodiment of the present invention. Thus, hereinafter, the structure of the dish washer according to the second preferred embodiment of the present invention will be briefly described. The detailed structures and functions of components not-described in detail and the connection therebetween are similar to those described with reference to FIGS. 1 to 3.

A sump 220 is communicated with a water supply pump 230 for pumping washing water, an exhaust pump 290 for exhausting the washing water, and a main passageway 261 for supplying the pumped washing water to a water jetting arm 211. A filtering device 250 including a sewage chamber 252 and a filter 251 is connected to the water supply pump 230 by an auxiliary passageway 262, and receives and filters some of the washing water pumped from the water supply pump 230. The auxiliary passageway 262, as shown in FIG. 5, may not pass through the exhaust pump 290, or, as shown in FIG. 1, may pass through the same.

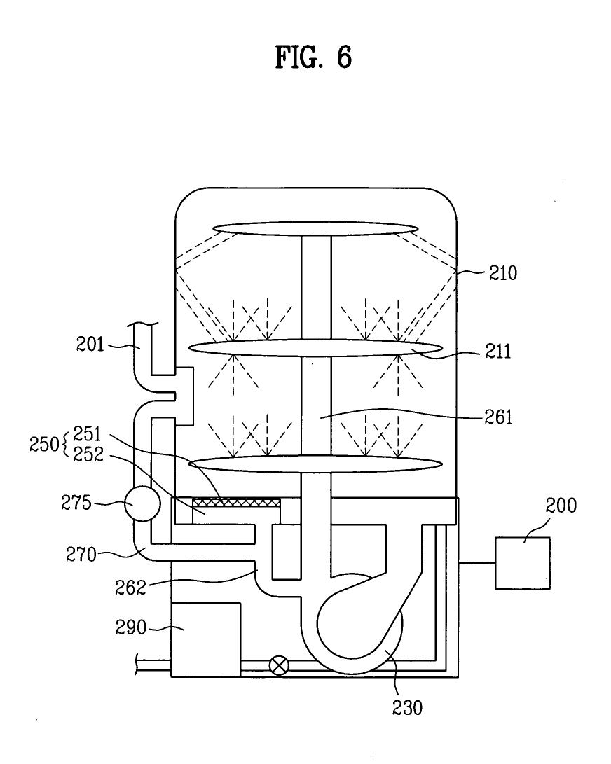

The sewage chamber 252 of the filtering device 250 is connected to a tub 210 by a bypass 270. Alternatively, the bypass 270 may be connected to the sump 220. An outlet of the bypass 270 is disposed higher than the filtering device 250. Although FIG. 5 illustrates an example of an inlet of the bypass 270 that is connected to the sewage chamber 252 of the filtering device 250, alternatively, the inlet of the bypass 270, as shown in FIG. 6, may be connected to the outer side or the inner side of the tub 210. In this case, in order to increase the inner space of the tub 210, the bypass 270 is preferably disposed outside the tub 210.

To the tub 210, for example, a water supply hose 201 may be connected, an outlet of the water supply hose 201 may be disposed higher than the outlet of the bypass 270. The outlet of the water supply hose 201 and the outlet of the bypass 270 may be integrally formed into a single unit so that the outlet of the water supply hose 201 and the outlet of the bypass 270 are connected to each other, or may be structured in the form of separate bodies separated from each other. Alternatively, the outlet of the water supply hose 201 may be directly connected to the sump 220.

As shown in FIGS. 5 and 6, the bypass 270 is provided with a second sensor 275 for measuring the pollution level of the washing water. The second sensor 275 is disposed at a position, for example, at a position higher than the filtering device 250. By doing so, the washing water activates the second sensor 275 only when the filtering device 250 is blocked.

The second sensor 275 includes, for example, a light emitting part (not shown) for generating light and a light receiving part (not shown) for receiving the light and outputting a voltage to a controlling part 200. The light emitting part and the light receiving part face each other and are interposed by the bypass 270. The light emitted from the light emitting part travels across the bypass 270 and reaches the light receiving part. At that time, when there is no the washing water in a part of the bypass across which the light travels, the light receiving part receives a large amount of the light and outputs a very high voltage. On the contrary, when heavily contaminated washing water passes through the bypass 270, the light receiving part receives a very small amount of light and outputs a very low voltage. In other words, the light receiving part outputs voltages of different intensities according to the pollution level of the washing water and transmits the voltages to the controlling part 200.

During the operation, when the filter 251 of the filtering device 250 is not blocked, the washing water pumped by the water supply pump 230, as shown in FIG. 5, is supplied to the filtering device 250 through the auxiliary passageway 262. Next, the washing water overflows from the filtering device 250 and is filtered, then is recovered to the sump 220. At that time, since the outlet of the bypass 270 is disposed higher than the filtering device 250, the pumped washing water 270 does not flow toward the tub 210 through the bypass 270. Thus, when the filter 251 of the filtering device 250 is not blocked, the washing water does not affect the second sensor 275, and as a result, the second sensor 275 outputs its highest voltage.

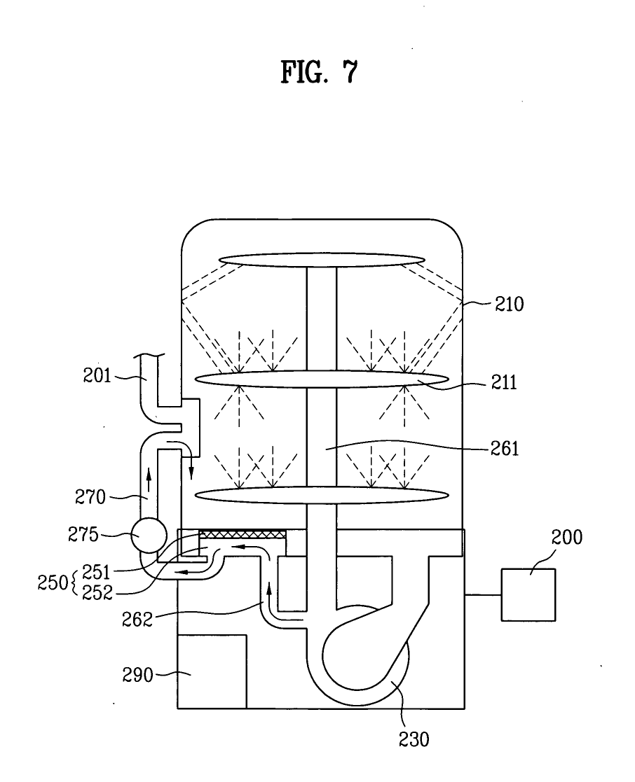

On the contrary, when the filter 251 of the filtering device 250 is blocked, the washing water pumped by the water supply pump 230, as shown in FIG. 7, cannot pass through the filtering device 250, but flows toward the tub 210 or the sump 220 through the bypass 270. The light emitted from the light emitting part, then, is scattered by the contaminated washing water and only a small amount of the light reaches the light receiving part. The amount of light, reaching the light receiving part, depends on the pollution level of the washing water, the light receiving part outputs voltages of different intensities to the controlling part 200 based on the pollution level of the washing water.

The controlling part 200 can precisely determine the pollution level of the washing water based on the intensity of the voltage received from the light receiving part, and adjusts the durations of the washing cycle and the rinsing cycle, and numbers of times the washing cycle or the rinsing cycle are performed, or the like based on the result of the determination.

Meanwhile, as described above, the dish washer according to the second preferred embodiment of the present invention measures the pollution level of the washing water with the second sensor 275 only when the filtering device 250 is blocked. By doing so, the pollution level can be more precisely measured, and a detailed description follows.

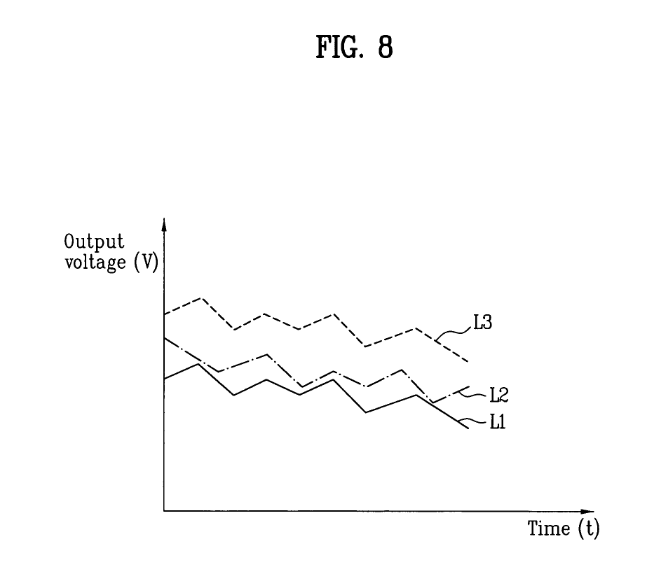

Contrary to as shown in FIGS. 5 to 7, it would be guessed that the second sensor 275 is installed at a position where the pollution level of the washing water is always measured, for example, in the sump 220, or in the auxiliary passageway 262. However, in this configuration, the pollution level cannot be measured more precisely than the configuration as shown in FIGS. 5 to 7. A description of the reason for this follows with reference to FIG. 8.

Firstly, in a case of heavily contaminated washing water, since the light emitted from the light emitting part is scattered due to a great deal of sewage, a small amount of the light reaches the light receiving part. Thus, the light receiving part, as shown in FIG. 8, outputs a voltage of low intensity in the pattern like L1. Here, the reason that the voltage of the light receiving part is gradually decreased as time passes is because the pollution level of the washing water is gradually increased as the washing cycle or the rinsing cycle is performed. Meanwhile, the controlling part 200 determines the L1 patterned output voltage range indicating a heavy pollution level.

In a case of light contaminate washing water, since the light emitted from the light emitting part is scatter due to a small amount of sewage, a relatively larger amount of the light reaches the light receiving part. Thus, the light receiving part outputs a voltage of high intensity in the pattern L3 as shown in FIG. 8. The controlling part 200 determines the L3 patterned output voltage range indicating a light pollution level.

In a case of intermediately contaminated washing water, the light receiving part outputs a voltage of intermediate intensity, generally exhibiting an L2 pattern between the L1 pattern and the L3 pattern. The controlling part 200 determines the L2 patterned output voltage range indicating an intermediate pollution level.

However, when the pollution level of the washing water is monitored in real time as described above there are the following disadvantages. During the washing cycle or the rising cycle, the washing water is continuously circulated through the sump 220 or the auxiliary passageway 262. The contents of foreign matter in the circulated washing water are continuously varied, when the pollution level of the circulated washing water is monitored in real time, the output range of the voltage of the light receiving part deviates over a large scale. Thus, as shown in FIG. 8, the graph of the output voltage in the heavy pollution level is overlapped with the graph of the output voltage in the intermediate pollution level, so that the controlling part 200 cannot precisely determine the pollution level of the washing water based on the intensity of the voltage outputted from the light receiving part.

In order to prevent the output voltage graphs, patterns L1, L2, and L3 from overlapping each other, the voltage difference between the output voltages should be large. In this case, since the pollution level is difficult to divide in a small scale, the dish washer cannot provide various washing services suitable to the pollution level of the dishes.

On the contrary, as shown in FIGS. 5 to 7, when the second sensor 275 measures the pollution level of the washing water only when the filtering device 250 is blocked, the above-described problem can be solved. Hereinafter, its detailed description will be followed.

Firstly, when the washing water is heavily contaminated during the washing cycle or the rinsing cycle, the output voltage of the second sensor 275 is the same as the pattern L4. When the filtering device 250 is blocked and the washing water starts to pass through the bypass 270, the light receiving part start to output a voltage of low intensity in the pattern L4. Since the washing water becomes more heavily contaminated as time passes, the intensity of the output voltage of the light receiving part is gradually lowered within a predetermined deviation. For example, when a predetermined periodic time lapsed or the output voltage from the light receiving part reaches a first threshold voltage, the controlling part 200 drives the exhaust pump 290 to exhaust the washing water. The intensity of the output voltage then rapidly increases.

When the washing cycle or the rinsing cycle is performed again after supplying fresh washing water, the washing water is gradually contaminated again. At that time, since the washing water still contains a lot of sewage, the filter 251 may be blocked. However, the pollution level of the washing water in a secondary time washing cycle or a secondary time rinsing cycle is lower than the pollution level of the washing water in a first time washing cycle or a first time rinsing cycle. Thus, the light receiving part outputs a voltage higher than the previous voltage. In the secondary cycle, for example, when a predetermined time has lapsed or the output voltage from the light receiving part reaches a second threshold voltage, the controlling part 200 exhausts the washing water.

As described above, when there is a heavy pollution level, the light receiving part outputs a very low voltage in the first cycle and a relatively higher voltage in the second cycle. Of course, in a third cycle, the light receiving part will output a voltage higher than the voltage outputted in the second cycle. Therefore, when the light receiving part outputs voltages in this pattern during the first and the second cycles, the controlling part determines that the washing water is heavily contaminated, and provides a suitable washing or a rinsing algorithm.

Next, in the intermediate pollution level of the washing water during the washing cycle or the rinsing cycle, the output voltage from the second sensor 275 is the same as the pattern L5. When the filtering device 250 is blocked and the washing water starts to pass through the bypass 270, the light receiving part starts to output a voltage of low intensity in the pattern L5. Here, the output voltage of the pattern L5 may be higher than the output voltage of the pattern L4 during the first cycle and lower than the output voltage of the pattern L4 during the second cycle. Since the washing water becomes more heavily contaminated as time passes, the intensity of the output voltage from the light receiving part gradually lowers within a predetermined deviation. For example, since the controlling part 200 exhausts the washing water as a predetermined time lapsed, the intensity of the output voltage from the light receiving part is rapidly increased.

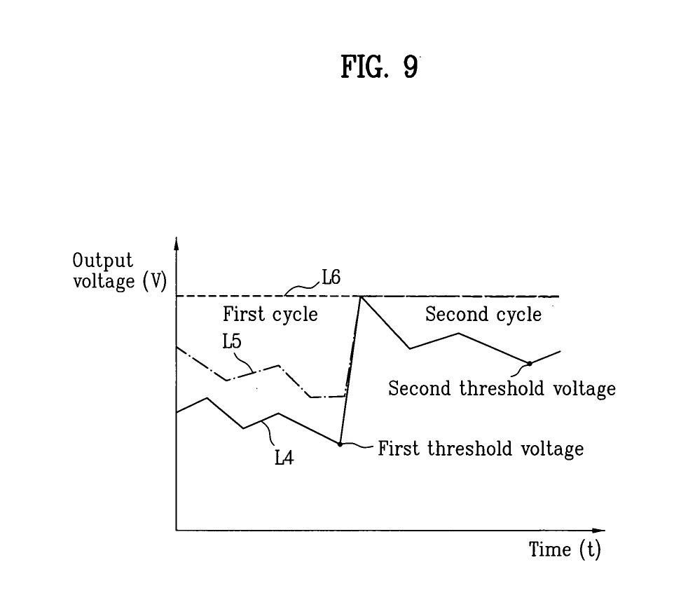

When the second cycle starts after the first cycle, the washing water gradually becomes heavily contaminated again. Since the washing water contains a smaller amount of sewage, generally the filtering device 250 is not blocked. Then, since the light receiving is not activated by the washing water, the light receiving part, as shown in FIG. 9, outputs the highest voltage uniformly.

As such, when there is an intermediate pollution level of the washing water, the light receiving part outputs an intermediate voltage during the first cycle and the highest voltage during the second cycle uniformly. Thus, with an intermediate pollution level of the washing water, the patterns of the output voltages during the first and the second cycles are very different from that when there is a heavy pollution level of the washing water. Based on this, the controlling part 200 determines that the washing water is contaminated at an intermediate pollution level, and provides washing and rinsing algorithms suitable to this.

Finally, when there is a light pollution level of the washing water during the washing cycle or the rinsing cycle, the output voltage of the second sensor 275 is the same as the pattern L6. Since the washing water contains a small amount of sewage during the washing cycle or the rinsing cycle, the filtering device 250 is not blocked. Thus, the light receiving part is never be activated by the washing water, and according to this, the light receiving part, as shown in FIG. 9, outputs the highest voltage during the first cycle.

For example, after a predetermined time has lapsed, the second cycle is performed. Since the filtering device 250 is not blocked during the second cycle, the light receiving part uniformly the highest voltage. The pattern L6 of the output voltage from the light receiving part is considerably different from the patterns L4 and L5 as described above. Thus, based on this, the controlling part 200 determines that the washing water is lightly contaminated, and provides washing and rinsing algorithms suitable to this.

As described above, when the second sensor 275 is installed at the position as shown in FIGS. 5 and 6, the controlling part 200 can very precisely determine the pollution level of the washing water. Moreover, as a basis for precise determination, the controlling part 200 provides a washing or a rinsing algorithm suitable to the pollution level of the dishes. Hereinafter, the controlling method of the dish washer according to the second preferred embodiment of the present invention will be described.

Firstly, the washing water is pumped by the water supply pump 230 and the pumped washing water is jetted toward the dishes through the water jetting arm 211 to perform the washing cycle or the rinsing cycle. Hereinafter, this cycle is referred to as a first cycle. Next, while the first cycle is performed, the washing water is filtered by the filtering device 250. Moreover, when the filtering device 250 is blocked, the washing water to be supplied to the filtering device 250 is bypassed through the bypass 270 and supplied to the tub 210 or the sump 220. The process in here is the same as the method for controlling the dish washer according to the first preferred embodiment of the present invention.

In the method for controlling the dish washer according to the first preferred embodiment of the present invention, whether the washing water flows through the bypass 270 or not is monitored, and the monitored result is reflected in the adjustment of the following cycles. To say again, when it is detected that the washing water flows through the bypass 270, the washing water is immediately exhausted or the second cycle is performed after a predetermined time has lapsed, while in the first preferred embodiment, the second cycle is performed identically to the first cycle.

On the contrary, the method for controlling the dish washer according to the second preferred embodiment of the present invention, when the washing water flows through the bypass 270, the pollution level of the washing water is measured and the measured result is reflected in the adjustment of the following cycles. Here, in order to precisely measure the pollution level of the washing water, the dish washer performs, for example, the cycle twice, the first cycle and the second cycle, and the second sensor 275 outputs a signal, that is, a voltage according to the pollution level of the washing water passing through the bypass 270 and transmits the voltage to the controlling part 200 when the filtering device 250 is blocked. The description related to this has been given with reference to FIG. 9.

As described above, according to the pollution level of the washing water, the patterns of the output signals, that is, the patterns of the output voltages during the first cycle and the second cycle are different from each other. Thus, the controlling part 200 compares the pollution level pattern acquired during the first cycle and the second cycle, that is, the combination of the patterns of the output voltages with a predetermined pattern to finally determine the pollution level of the washing water. After determining the pollution level of the washing water, the controlling part 200 compensates the washing time or the rinsing time of the dishes and numbers of times the respective cycles are to be performed based on the determination, and the dish washer performs the corresponding cycles according to the compensated washing or rinsing algorithm.

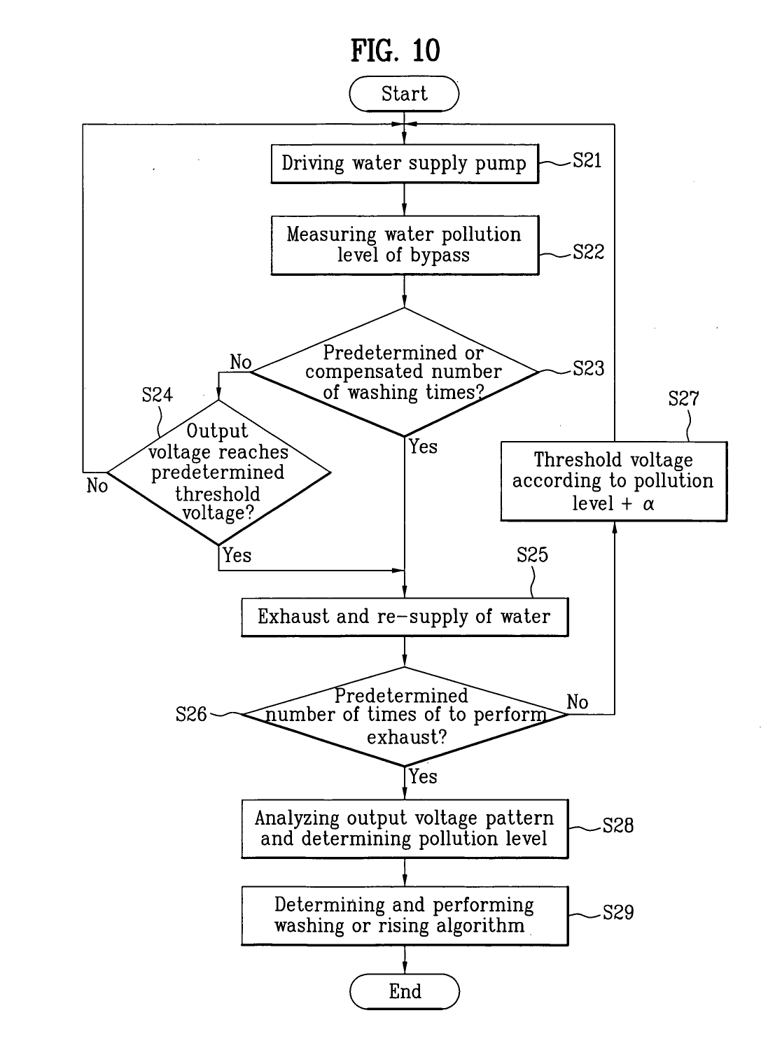

Hereinafter, how to apply the controlling method of the dish washer according to the second preferred embodiment of the present invention including the above-described processes when the dish washer is actually operated will be described in detail with reference to FIG. 10.

When starting the washing cycle, the water supply pump is driven (S21). Moreover, the controlling part 200 measures the pollution level of the washing water flowing through the bypass 270 with the second sensor 275 (S22). In the controlling part 200, the range of the output voltages is predetermined according to the pollution level of the washing water and the threshold voltages are predetermined according to the pollution level of the washing water. The threshold voltages means a reference for performing exhaust and re-supply of the washing water when the threshold voltage is outputted at the corresponding pollution level. This threshold voltage performs a function of preventing the pollution level from further increasing the respective pollution levels.

Next, whether the predetermined or the compensated washing time or the compensated rinsing time has lapsed or not is determined (S23). If the washing time or the rinsing time has not lapsed, the controlling part 200 determines whether the voltage outputted from the second sensor 275 has reached the predetermined threshold voltage or not (S24). If the output voltage has not reached the threshold voltage, the controlling part returns back to the step S21 and repeats the above-described processes.

Meanwhile, when the predetermined or the compensated washing time has lapsed as a result of the determination in the step S23, or when the output voltage has reached the threshold voltage as a result of the determination in the step S24, the controlling part 200 exhausts the washing water in the sump 220 and starts to supply the washing water again (S25). Here, in view of reducing the pollution level, it is advantageous to exhaust all of the washing water, and in view of saving the washing water, it is advantageous to exhaust some of the washing water.

For example, during or after the step S25, the controlling part 200 determines whether a present number of times to perform the exhaust has reached a predetermined number of times to perform the exhaust (S26). If the predetermined number of times to perform the exhaust is one, since the exhaust is already performed once, the controlling part 200 performs the next step. On the contrary, if the predetermined number of times to perform the exhaust is two, since the number of times to perform the exhaust has not reached the number of time to perform the exhaust yet, the controlling part 200 repeats the processes from the step S21.

Although not depicted in the drawings, the controlling part 200 can compensate the washing time before performing the step S21 again. This is why it is preferable that the water quality is changed after the re-supply of the washing water and the washing time is modified according to the changed washing water. Additionally, the controlling part 200, as shown in FIG. 10, can set the threshold voltage higher than the previous value by a predetermined value α. In other words, as shown in FIG. 9, a second threshold voltage after the re-supply of the washing water is determined is higher than a first threshold voltage before the washing water was re-supplied. This reason why is, although the re-supplied washing water is contaminated, the washing water is contaminated less than the previously supplied washing water, if the same threshold voltage is allowed before and after the re-supply of the washing water, the washing water cannot be exhausted and re-supplied even when the filtering device 250 is blocked after the re-supply of the washing water.

Meanwhile, when the number of times to perform the exhaust reaches the predetermined number of times to perform the exhaust by repeating the processes from the step S21 to the step S26, the controlling part 200 combines the patterns of the voltages outputted during the respective cycles already performed and compares the combination of the patterns with the predetermined reference pattern. In other words, as described above in FIG. 9, after combining the patterns of the voltages outputted during the first cycle and the second cycle into a single pattern, the controlling part 200 compares the single pattern with the predetermined reference pattern. With this method, the controlling part 200 precisely determines the pollution level of the washing water (S28).

After the determination of the pollution level of the washing water, the controlling part 200 compensates the washing time or the rinsing time based on the determination, and finally performs the finally determined washing or the rinsing algorithm (S29).

As described above, the dish washer according to the second preferred embodiment of the present invention and the controlling method thereof directly measures the pollution level of the washing water passing through the bypass when the filtering device is blocked, and applies the measured result to the washing or the rinsing algorithm of the dish washer. Further, since the pollution level of the washing water is finally determined using the pattern of the pollution level measured while performing the cycles several times, the pollution level can be precisely determined without error. Thus, the precise washing and rinsing algorithms based on the pollution level of the washing water can be divided on a small scale, and according to this, the consumption of the washing water and the power consumption can be reduced. In addition, heavily contaminated dishes can be also washed more effectively.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

For example, in the above description, the dish washers according to the first and the second preferred embodiments of the present invention as well as the controlling methods thereof are described, respectively. However, the dish washer according to the present invention may be provided in the form of the combination of the dish washer according to the first preferred embodiment and the dish washer according to the second preferred embodiment. For example, both of the first sensor and the second sensor may be provided to the bypass. For another example, the first sensor may be provided to the dish washer according to the second preferred embodiment of the present invention, and the second sensor may be provided to the dish washer according to the first preferred embodiment of the present invention. In these cases, the methods for controlling the dish washers may be also provided in the form of the combination of each other.

Therefore, it should be understood that the above-described embodiments would not be limited and illustrative, and all the embodiments and the appended claims come within the scope of the present invention.

What is claimed is:

1. A dish washer comprising:
a sump communicated with a tub to accommodate water;
a water supply pump for pumping the water in the sump;
a filtering device for receiving a part of the water pumped through an auxiliary passageway to filter the pumped water and to supply the filtered water to the sump again; and
a bypass for bypassing the water to be supplied to the filtering device to the tub or the sump when the filtering device is blocked by sewage.

2. The dish washer as set forth in claim 1, wherein the filtering device comprises:
a sewage chamber for accommodating the water and the sewage entering through the auxiliary passageway; and
a filter provided above the sewage chamber to filter the water overflowing from the sewage chamber.

3. The dish washer as set forth in claim 1, wherein the bypass is configured to connect the filtering device to the tub or the sump.

4. The dish washer as set forth in claim 1, wherein the bypass is configured to connect the auxiliary passageway to the tub or the sump.

5. The dish washer as set forth in claim 1, wherein the bypass includes a part positioned higher than the filtering device such that the water entering the filtering device is prevented from flowing toward the tub or the sump when the filtering device is not blocked.

6. The dish washer as set forth in claim 1, further comprising a sensor for detecting whether the filtering device is blocked or not by detecting the water flowing toward the tub or the sump through the bypass.

7. The dish washer as set forth in claim 1, further comprising a tank provided in the intermediate region of the bypass to deposit sewage contained in the water flowing toward the filtering device.

8. The dish washer as set forth in claim 1, further comprising an exhaust pump communicated with the sump such that the water in the sump is exhausted through an exhaust hose and sewage contained in the water flowing toward the filtering device is deposited in the exhaust pump.

9. The dish washer as set forth in claim 8, wherein the exhaust hose includes a part disposed higher than the bypass to prevent the water entering the exhaust pump through the auxiliary passageway from exhausting when the water passes through the bypass.

10. The dish washer as set forth in claim 1, further comprising a sensor provided in the bypass to measure the pollution level of the water when the water passes through the bypass.

11. The dish washer as set forth in claim 10, wherein the sensor is disposed higher than the filtering device such that the sensor is prevented from being activated by the water when the filtering device is not blocked.

12. A controlling method of a dish washer comprising the steps of:
performing a washing cycle or a rinsing cycle;
monitoring whether a filtering device, through which water passes, is blocked due to sewage or not;
repeating the washing cycle or the rinsing cycle until the filtering device is not blocked; and
further performing the washing cycle or the rinsing cycle once again when the filtering device is not blocked until one of the washing cycle or the rinsing cycle is completed and finishing the repetition of the washing cycle or the rinsing cycle.

13. The controlling method of a dish washer as set forth in claim 12, wherein the step of monitoring whether the filtering device is blocked or not is performed by detecting whether the water to be supplied to the filtering device flows through a bypass for communicating a tub for accommodating dishes or a sump for accommodating the water to the filtering device.

14. The controlling method of a dish washer as set forth in claim 12, further comprising the step of outputting an error message when the rinsing cycle or the washing cycle is performed as many times as a predetermined threshold number of performance times.

15. The controlling method of a dish washer as set forth in claim 12, further comprising the step of heating the water and performing an additional rinsing cycle with the heated water after a final rinsing cycle.

16. A controlling method of a dish washer comprising the steps of:
pumping and jetting water toward dishes accommodated in a tub;
filtering the water with a filtering device; and
bypassing the water to be supplied to the filtering device through a bypass to the tub or a sump for accommodating the water when the filtering device is blocked.

17. The controlling method of a dish washer as set forth in claim 16, further comprising the steps of:
detecting whether the water flows toward the tub or the sump through the bypass or not; and
exhausting and re-supplying the water when the water flows toward the tub or the sump through the bypass.

18. The controlling method of a dish washer as set forth in claim 16, further comprising the steps of:
detecting whether the water flows toward the tub or the sump through the bypass or not; and
repeating a corresponding cycle once again after the corresponding cycle is finished when the water flows toward the tub or the sump through the bypass.

19. The controlling method of a dish washer as set forth in claim 16, further comprising the steps of:
measuring the pollution level of the water flowing toward the tub or the sump through the bypass; and
exhausting the water when the measured pollution level exceeds a predetermined pollution level and re-supplying the water.

20. The controlling method of a dish washer as set forth in claim 19, further comprising the steps of:
measuring the pollution level of the water again when the filtering device is blocked again after the re-supply of the water; and
comparing a combination of a pattern of the pollution level measured prior to the re-supply of the water and a pattern of the pollution level measured after the re-supply of the water with a predetermined pattern to determine the pollution level of the water.

21. The controlling method of a dish washer as set forth in claim 19, further comprising the step of compensating the number of washing times or the number of rinsing times after the re-supply of the water.

22. The controlling method of a dish washer as set forth in claim 19, wherein the pollution level of the water is measured based on the intensity of output voltage generated from a sensor according to the amount of light passing through the water passing through the bypass.

23. The controlling method of a dish washer as set forth in claim 19, further comprising the step of adjusting reference values for determining the pollution level of the water after the re-supply of the water by increasing the reference values.

24. A controlling method of a dish washer comprising the steps of:
performing a washing cycle or a rinsing cycle at least twice;
detecting water when a filtering device is blocked during respective cycles and outputting signals according to the pollution levels of the water; and
comparing a combination of patterns of the signals outputted during the cycles performed twice with a predetermined pattern to determine the pollution level of the water.
